(19) United States
(12) Patent Application Publication
(10) Pub. No.: US 2011/0008016 A1
(43) Pub. Date: Jan. 13, 2011

(54) DIGITAL MICRO AD (DMA) CONTENT DELIVERY SYSTEM AND METHOD

(75) Inventors: Steve DeLaney, Carlsbad, CA (US); Floyd W. Kaylor, Yorba Linda, CA (US); Mark Rybarczyk, Kennett Square, PA (US)

Correspondence Address: Cionca Law Group P.C., 333 City Blvd W, Ste 1700, Orange, CA, 92868, US

(73) Assignee: STEALTH MARKETING INC., Wilmington, DE (US)

(21) Appl. No.: 12/779,027

(22) Filed: May 12, 2010

Related U.S. Application Data
(60) Provisional application No. 61/224,708, filed on Jul. 10, 2009.

(51) Int. Cl. H04N 5/91

(52) U.S. Cl. 386/249; 386/E05.003; 386/351

(57) ABSTRACT

A Digital Micro Ad (DMA) system and method designed to adapt to changing viewer behavior by detecting spot fast-forward, or other trick play, and popping a graphic, or other messages, over video. This graphic displays the advertiser brand message to achieve a brief imprint on the viewer. The DMA system augments the linear advertisement or the like (the spot) so the advertiser can reach their intended target audience. The system starts with offline media processing. Off the shelf encoded spots are processed to embed DMA enabling content identifying “metadata” packets and in-line graphics images. Next, when the content is played to air, this DMA enabled content is streamed to the DVR device. Within the DVR, the DMA engine detects the embedded graphic images which are recovered and saved in the DVR. Finally, when a DVR recorded program is played back, the embedded content ID metadata packets “arm” the DMA engine. When the content is fast-forwarded for example, over the spot, a graphic image may be popped into the graphics plane over the fast-forwarding video image, and is timed to persist for a few seconds to make the impression.

### CROSS-REFERENCE TO RELATED APPLICATIONS

This application claims priority from U.S. provisional patent application No. 61224708, titled Stealth Interactive Overlays, and filed with the USPTO on Jul. 10, 2009, the content of which is incorporated by reference herein.

### BACKGROUND OF THE INVENTION

1. Field of the Invention

The present invention relates generally to video technology and particularly to a method and system for displaying a substitute message when media content is played using trick play modes.

2. Description of the Related Art

Tivo-like DVR devices, including storage based cable Set Top Boxes, have allowed users to time-shift content so commercial spots can be fast-forwarded. Recent studies have shown that a range of media choices starting with DVR program archives have displaced on-demand programs (see http://andrewpburke.wordpress.com/ Jul. 14 2009 blog). DVR and catch-up TV changes the ground rules for traditional ad sponsored linear broadcast, since this circumvents the commercial message and diminishes the effectiveness of the advertisement.

Using DVR appliances, viewers can playback recorded media and skip over sponsored advertisements, public service announcements, and other content. Media content is currently tailored to existing network delivery systems and DVR appliances (i.e., the infrastructure). Therefore, a practical solution must be transparent to this existing infrastructure. Furthermore, secondary content (i.e., substitute message (e.g., a graphic)) must be independent of recorded media so it can be loaded independently and updated from time-to-time.

Some attempts were made to solve some of these problems, as suggested by the references below. However, the solutions proposed by these references are expensive, difficult to implement, and/or they give little or no control to the advertiser.

U.S. Pat. No. 7,512,321 to Tsuru, et al., (“Tsuru”) discloses a video recording/playback system for recording and playback of video data received, which consists of sets of main data (e.g., TV program) and sub data (e.g., spot commercial). The same ID code is assigned to the main data and sub data. The sets of main data, sub data, ID code and substitute data (e.g., advertiser's logo) are embedded in advance in the video data. The substitute data (advertiser's logo, etc) in a program data is associated in advance with the commercial data coupled with the program data. The video recording/payback system includes control means designed to check if the sub data (e.g., spot commercial) was normally played. If the sub data (e.g., spot commercial) has not been normally played in a playback process (e.g., user used the fast-forward command), its substitute data (advertiser's logo, etc) is incorporated into the program data so that the substitute data will be superimposed on the video of the program following the commercial. In a sense, substitute data (advertiser's logo, etc) embedded in program data is a backup for commercial data associated with the program data and functions as insurance against a missing commercial.

U.S. Pat. No. 7,440,674 to Plotnick, et al., (“Plotnick”) teaches a method for presenting viewers with an alternative brief version of a recorded ad when they choose to fast-forward through or skip (or any other trick play event) the recorded ad. The alternative ad may be displayed instead of or in conjunction with the recorded ad (i.e., fast-forwarding ad is displayed in one portion of the screen (i.e., background or portion of a split screen) and the alternative brief version is displayed in another portion). The alternative brief version of the ad (trick play advertisement) may be a marketing message that is a static screen presenting a logo or a portion of the recorded ad, or may be a condensed version of the actual ad. The alternative ad can be generated or received as a separate file by the PVR. A number of events such as fast-forward, commercial skip, and rewind can be used to trigger the alternative ad and are known in general as trick-play events. The alternative ad can be received by the PVR, DVR, or other similar devices, with the video stream, separate from the video stream. Furthermore, the alternative ad can be received from the same video source, from the advertiser, or from any other external source via the same video delivery network or via a different network. The alternative ad may have a format similar (i.e., MPEG-2) to that of the ad, or it may have a separate format, such as HTML, streaming media, Flash, Shockwave, or other formats well known to those skilled in the art. It is also possible to have multiple alternative ads delivered to the PVR and stored thereon. The processing rules will ensure that the display of the ad is triggered by a trick play event (fast-forward, etc). The processing rules can be ad specific and be sent to the PVR with the video stream, which includes the ad, or it can be sent separately. The processing rules can also be generic, as opposed to ad specific, and they can be preloaded in the PVR, for example at the time of purchase, or loaded by the network operator via the video delivery network or via a separate network.

U.S. Pat. No. 7,333,712 to Jeannin, et al., (“Jeannin”) relates to a method and system for providing the creation of a visual summary of a video source during fast forward/rewind of the video (spot commercial, etc). The visual summary can be created by extracting frames either automatically or manually from the original video to create an initial visual summary. A series of weights may be assigned to the extracted frames, which are then filtered according to the relative weights to create a modified visual summary. The keyframe display rate is then adjusted according to the fast forward/rewind speed, which can be either a standard speed or user selected speed, so as to display the keyframes while the video source is being fast forwarded/rewound. The keyframes may be substituted by selected images and audio, so that an advertiser can substitute an image of the product and a brief audio summary while the user is fast forwarding/rewinding past the commercial message.

U.S. Pat. No. 6,614,844 to Proehl, (“Proehl”) describes an invention which takes advantage of the additional flexibility provided by the MPEG-4 standard by including metadata that varies the visual content on a screen based on the playback mode. More particularly, the format according to the invention has a main video portion that includes primary content data to be displayed during a normal viewing mode and a metadata portion that includes watermark data corresponding to the primary content data and instructions for displaying the watermark data during a modified mode, such as a fast playback (e.g., fast forward or fast reverse) mode. The watermark data itself can be any information that a program producer or advertiser wishes to be displayed when the program is played in the modified playback mode. The watermark can be displayed in any manner, such as by superimposing the watermark over the primary program content, removing the primary program and displaying the watermark by itself, or displaying the watermark in one portion of the screen and the primary program content in the remaining portion of the screen.

US Patent Application 20080313668 discloses in very broad terms a system and method for substituting a shorter message, comprising sound, picture or both, for a longer advertisement or the like. The message may to communicate to the viewer that there is a message of a particular type being passed by or may simply provide a shorter message. The shorter message may be an abbreviated version of the longer message, or may be a completely different shorter message.

Patent Application EP1090356/WO 00/57295 teaches that a hot spot is encoded in portions such as the display data portion of a television signal such that the encoded hot spot data is unaffected by any alteration to television signals performed by intermediate broadcasters. Hot spot data may include data identifying the location of hot spots in an image frame and vendor system data associated with the hot spot. A transaction enabler block may display images represented by the image frames and enable a viewer to access vendor systems by selecting the hot spot areas via remote control.

As mentioned earlier, the solutions proposed by these references are expensive, difficult to implement, and/or they give little or no control to the advertiser. Giving control to the advertisers it is very important and the solutions proposed by these references fail to do that. This is why, these solutions have not been adopted and implemented by the media industry, which still views fast forwarding through purchased advertising as a major drain on its financial resources. Furthermore, unlike the above proposed solutions, the DMA content delivery system is not based on a watermark or any other alternation at the video or audio elementary stream layer. In addition, the DMA content ingest can be applied to existing content assets to repurpose the content with DMA metadata applied at system layer. Moreover, the DMA content delivery system secondary content is independent of ingested media content and can be flexibly delivered to the DVR and synchronized to the played back content under control of the DMA engine.

The problems and the associated solutions presented in this section could be or could have been pursued, but they are not necessarily approaches that have been previously conceived or pursued. Therefore, unless otherwise indicated, it should not be assumed that any of the approaches presented in this section qualify as prior art merely by virtue of their presence in this section of the application.

### BRIEF SUMMARY OF THE INVENTION

The present invention solves the above enumerated problems. According with the present invention, media content is ingested by multiplexing with DMA (Digital Micro Ad) metadata. The DVR is augmented with a software library that senses viewer VCR controls and the presence of DMA content metadata. When the DMA multiplexed content is skipped, a secondary content (i.e., substitute message) is displayed. The secondary content can be a graphic image, picture-in-picture (e.g., a shorter version of the video commercial), audio, or in combination, but is not limited to these content types. In addition, the DMA content ingest is compatible and transparent to existing infrastructure. The content ingest process is implemented at the content system layer and does not require video or audio transcoding. The DMA secondary content is independent of the recorded media. It can be pre-loaded, updated out of band, or multiplexed in-band in the media along with DMA metadata. The DMA engine achieves secondary content display by implementing isolated interfaces to DVR player allowing it to be easily integrated in the DVR and flexibly interfaced to various in-DVR players.

The Digital Micro Ad (DMA) system adapts to changing viewer behavior by detecting spot fast-forward, or other trick play event, and popping a graphic, or other substitute messages, over video. This graphic displays the advertiser brand message to achieve a brief imprint on the viewer. The DMA system augments the linear spot so the advertiser can reach their intended target audience. The system starts with offline media processing. Off the shelf MPEG2 encoded spots are processed to embed DMA enabling content identifying “metadata” packets and in-line graphics images. Next, when the content is played to air, this DMA enabled content is streamed to the DVR device. Within the DVR, the DMA engine detects the embedded graphic images which are recovered and saved in the DVR. Finally, when a DVR recorded program is played back, the embedded content ID metadata packets “arm” the DMA engine. When the content is fast-forwarded, for example, over the spot, a graphic image may be popped into the graphics plane over the fast-forwarding video image, and is timed to persist for a few seconds to make the impression.

### BRIEF DESCRIPTION OF THE DRAWINGS

For exemplification purposes, and not for limitation purposes, embodiments of the invention are illustrated in the figures of the accompanying drawings, in which:

FIG. 1 illustrates the end-to-end DMA system including content management and ingest 101, DMA enabled content 102, in-band streaming comprising the DMA metadata packets 103, graphic images 104, and MPEG video and audio 105, out-of-band streaming of updated graphic images 106, and DVR device 107 with DMA enabled DVR player 108, in accordance with several embodiments of the present invention.

FIG. 2 illustrates the conceptual design of the content ingest mux (cmux) with its inputs, the metadata job file 201, spot files 202, and its outputs, the DMA enabled spot files 203 and job log file 204, in accordance with several embodiments of the present invention.

FIG. 3 illustrates an external view of a DVR device 301, with a DMA enabled DVR player, and DMA associated content: DMA enabled spot files 302, DMA graphics files 303, and content catalog 304, in accordance with several embodiments of the present invention.

FIG. 4 shows an internal view of the DVR player 401 and DMA engine 402, and the Linux runtime 403 and other system services 404 being interfaced to both the DVR player 401 and DMA engine 402, in accordance with several embodiments of the present invention.

FIG. 5 illustrates the DMA engine and external player related elements, including components, interfaces and dataflows, and content.

FIG. 6 illustrates the DMA engine elements.

### DETAILED DESCRIPTION OF THE INVENTION

What follows is a detailed description of specific embodiments of the invention in which the invention may be practiced. Reference will be made to the attached drawings, and the information included in the drawings is part of this detailed description. The specific embodiments of the invention, which will be described herein, are presented for exemplification purposes, and not for limitation purposes. It should be understood that structural and/or logical modifications could be made by someone of ordinary skills in the art without departing from the scope of the present invention. Therefore, the scope of the present invention is defined only by the accompanying claims and their equivalents.

It is to be understood that while the term digital video recorder (DVR) is predominantly referred to herein, the term DVR is to be understood broadly to encompass any device with similar functionality, and which may be known under different names, as for example, PVR or set-top-box. Also, while the term fast-forward is predominantly used herein when referring to the trick play mode of the DVR, it is to be understood that the teachings of the present invention may be equally implemented in other trick play modes of the DVR, as for example, rewind, skip or pause. Furthermore, while commercial spot (spot) refers generally to a spot having both, a video and an audio component, a spot may have only a video or only an audio component. Moreover, the following terms have the same meaning and will be used herein interchangeably: DMA metadata packets, private data packets, DMA control private data packets, DMA private data packets, DMA control, DMA control packet, control private data packet, metadata control, metadata control information, metadata triggers, DMA triggers, and triggers. Also, the terms overlaid graphic, graphic overlay, DMA graphic overlay, graphic images and graphic file, have the same meaning here.

In addition, while an overlaid graphic is mainly used to describe how a desired visual impression may be achieved, when the DVR is in a trick play mode, it is to be understood that an audio impression (e.g., a voice recording of the name and/or the slogan of the advertiser) may also be used instead of a visual impression. Moreover, the visual impression can be a 2D or a 3D graphic, or a motion picture. Furthermore, the visual and the audio impressions can be used separately or simultaneously. In addition, while the present disclosure concerns itself primarily with trick play of commercial spots, one of ordinary skills in the art would recognize that the teachings of the present invention may be applied to any video played in trick mode. Moreover, while primarily the focus herein is on MPEG2 file format, one of ordinary skills in the art would recognize that other MPEG or non-MPEG file formats may be used in connection with the teaching of the present invention in order to achieve similar results.

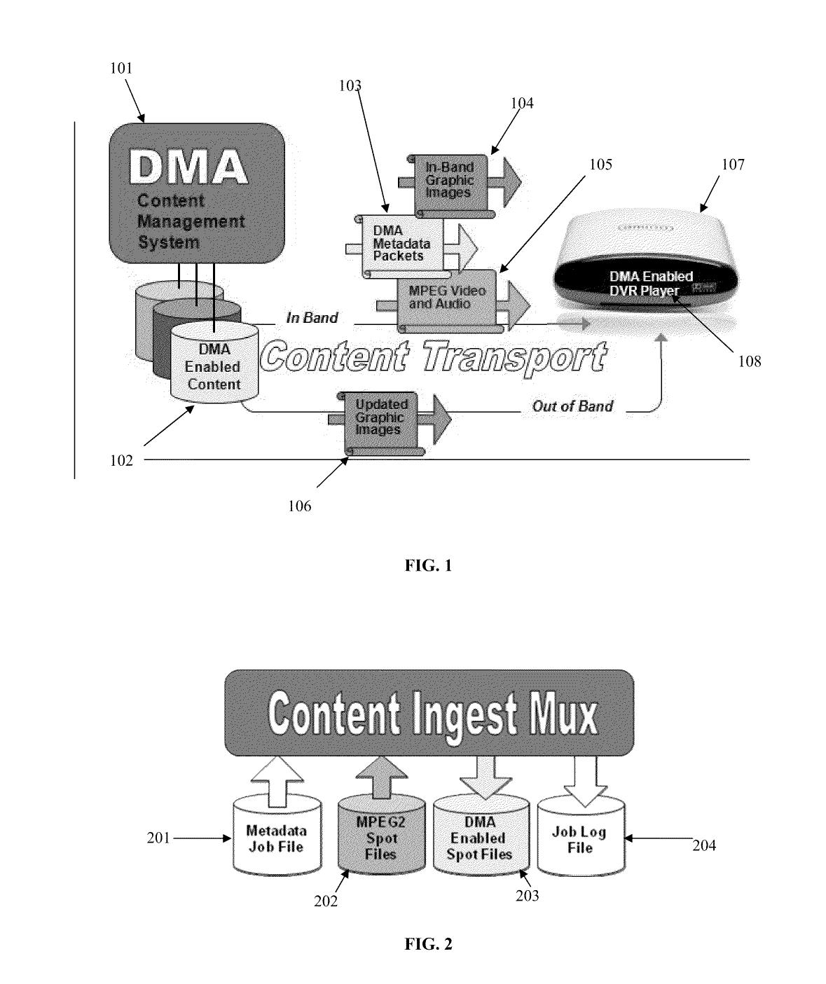

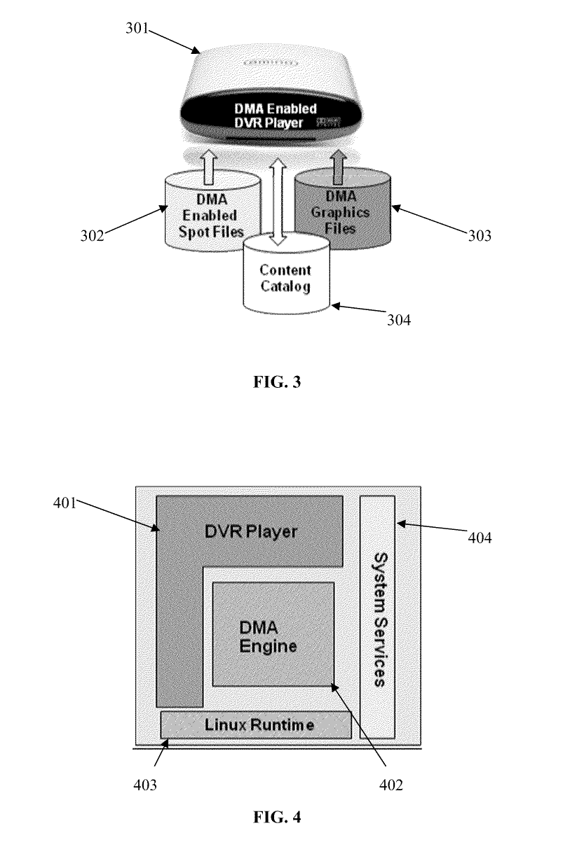

FIG. 1 illustrates the end-to-end DMA system including content management and ingest 101, DMA enabled content 102, in-band streaming comprising the DMA metadata packets 103, graphic images 104, and MPEG video and audio 105, out-of-band streaming of updated graphic images 106, and DVR device 107 with DMA enabled DVR player 108, in accordance with several embodiments of the present invention.

The system starts with offline media processing. Off the shelf MPEG2 encoded spots are processed to embed DMA enabling content identifying “metadata” packets 103 and in-line graphics images 104. Next, when the content is played to air, this DMA enabled content 102 is streamed to the DVR device. Within the DVR, the DMA engine detects the embedded graphic images 104 which are recovered and saved in the DVR. Finally, when DVR recorded program is played back, the embedded content ID metadata packets 103 “arm” the DMA engine. When the content is fast-forwarded over the spot, the graphic image is popped into the graphics plane over the fast-forwarding video image, and is timed to persist for a few seconds to make the impression.

The system includes support for updated graphic images 106. DMA graphic images 104 are first downloaded “in-band”, together with the live streamed video 105. The graphic is associated to the spot by a spot ID. Graphics can be refreshed over time by loading new graphics referencing the same spot ID. It may be possible to vary the graphics by having several graphics associated to the same spot ID. This could be used for example to support a lineup rotation, contest image one day and coupon the next, and so on.

Graphics are managed by the back-end content server. The DVR 107 includes TCP/IP support so the client DVR can initiate content “pull” over the operator network from the DMA content server. This approach offers a flexible content model supporting in-band, out-of-band, push and pull depending on the ultimate preferred operations workflow.

FIG. 2 illustrates the conceptual design of the content ingest mux (cmux) with its inputs, the metadata job file 201, spot files 202, and its outputs, the DMA enabled spot files 203 and job log file 204, in accordance with several embodiments of the present invention. The content ingest mux, or cmux, will implement a batch oriented workflow to process file to file. Cmux will input the metadata job file name on command line, parse the metadata job file to extract the batch session information including spot file input and output file names, then open and process the spot files. The input spot file 202 would typically be an input MPEG2 transport stream file format ISO 13818-1 containing audio and video, or an MPEG4 container file format.

Cmux will scan input spot file for I frames, and for each instance, insert the DMA control section (defined in the Table 02 below), in private data packet. This will insert a relatively small chunk of metadata control information to be co-incident with the video I-Frame. This control is ultimately used by the DMA engine to process graphic overlays. When the DMA spot is played by the client player, the triggers are extracted and the player can overlay graphics, etc. When a DVR archive is fast forward, the player jumps I-frame to I-frame and may skip I-frames at higher fast forward speed like 64×. With the DMA control repeated at each I-frame, there is a high probability of landing on it when fast-forwarding. Metadata private data packets are not restricted to I-frame boundaries and can be inserted anywhere in the content stream. Cmux implements a saturation level property to control the frequency that metadata is inserted. This allows the content ingest to be tuned for various network operations and viewer interactions.

For DMA control type “trigger”, the DMA packet will normally just repeat i-frame by i-frame, but the implementation should allow for some cycling pattern of different metadata packets. For example, there will be support for in-band graphics. In this case, a sequence number needs to be inserted into the DMA control section, so that can later be used by the client engine to re-assemble the graphic file in the DVR local storage.

Each time a file is processed by the cmux, it will append simple text record to the job log file 204. The file should be comma delimited so it can be imported into a spreadsheet like Excel. Each text record will include for example these fields echoed from the metadata control file, along with batch session completion status, counters and statistics, etc.

TABLE 01

| Field | Description |
|---|---|
| Timestamp | Date and time spot file was processed |
| Spot ID | Uniquely identifies the associated spot file |
| Input Spot file | Name of input spot file (example, spot_123.ts) |
| name | |
| Output Spot file | Name of input spot file (example, spot_DMA_123.ts) |
| name | |
| I-frame count | Number of i-frames scanned in the input file (and |
| | implicitly the number of inserted private DMA control |
| | packets) |
| Status | OK, Fail, File Not Found, etc |

The cmux may implement simple session context support using environment variables or INI file to define default parameters like file paths to spot files, default field values, etc.

Central to the interaction of the DMA system is the metadata file. While ultimately the metadata file will be exported from a content management server, for a limited prototype purpose, a simple text based metadata file format is sufficient. A typical way this would be implemented would be XML based. For a limited prototype purpose a simple name-value pair structure can be used similar to INI file. The parsing APIs are already implemented.

The format and associated parsing tools are flexible and easy to use. Metadata fields can be added or modified as the needs of the system evolve. Ultimately the system is intended to support binary files with in-band graphics. The graphic file can be referenced from the metadata file by including the file name. Thus, the metadata file may be all ASCII text.

The metadata record is organized into 3 sections. The record is present in the job file, and is also used as the format for DMA control messages. Section 1 defines Action Codes M-3 and M-4 that are also used by DMA engine to implement DMA control element described in Table 4 entry 601. Sections 2 and 3 contain additional DMA payload information. The metadata record in its entirety, including sections 1-3, is inserted as private data into the content file. This method can be used both for off-line file ingest, and live stream content metadata insert. The job format is shown in the following table:

TABLE 02

| | | | |
|---|---|---|---|
| # | Field Name | Field Type | Description |

SECTION 1 - METADATA CONTROL

| | | | |
|---|---|---|---|
| M-1 | Revision level | Numeric | Defines the revision level of |
| | | | metadata section. Used for |
| | | | backward compatibility as file |
| | | | format is modified |
| M-2 | Metadata file | Numeric | Uniquely identifies this metadata |
| | ID | | job file |
| M-3 | Action Code 1 | Numeric | One of MUX, DMX_PACKET, |
| | | | EVENT |
| M-4 | Action Code 2 | Numeric | Action Code 1 dependent. For |
| | | | EVENT this field is one of |
| | | | EVENT_PLAY, EVENT_FFWD, |
| | | | etc. |

SECTION 2 - DMA TRIGGER

| | | | |
|---|---|---|---|
| C-1 | Revision level | Numeric | Defines the revision level of |
| | | | metadata section. Used for |
| | | | backward compatibility as file |
| | | | format is modified |
| C-2 | Spot ID | Numeric | Uniquely identifies the associated |
| | | | spot file |
| C-3 | Lineup Number | Number | Future use - for cases where |
| | | | multiple graphics and DMA |
| | | | controls are associated with one |
| | | | spot. Allows change in |
| | | | graphics lineup |
| | | | Default value = 1 |
| C-4 | Sequence | Numeric | Generated at job time by cmux. |
| | number | | Default value = 1 for content type |
| | | | “trigger” |

SECTION 3 - DMA CONTENT

| | | | |
|---|---|---|---|
| C-5 | Input File type | String | “TS” 13818 transport stream |
| C-6 | Input Spot file | string | Name of input spot file (example, |
| | name | | spot_123.ts) |
| C-7 | Output Spot | string | Name of output spot file (example, |
| | file name | | spot_DMA_123.ts) |
| C-8 | Control type | string | “trigger” or “graphics”. |
| C-9 | Content type | string | “JPEG”, “BMP”, “TXT” |
| C-10 | Content name | string | Name of content file |
| | | | “DMA_123.jpg” |
| C-11 | Active date | Date string | Calendar date when DMA control |
| | | yymmdd | becomes valid |
| C-12 | Expire date | Date string | Calendar date when DMA control |
| | | yymmdd | becomes invalid |
| C-13 | Clip Width | Numeric | Resolution width for the video clip |
| | | | that this content relates to. Used |
| | | | for overlay screen placement |
| C-14 | Clip Height | Numeric | Resolution height for the video clip |
| | | | that this content relates to. Used |
| | | | for overlay screen placement |

Since the prototype metadata file is organized like an INI file, an existing INI parser utility, parse_conf.c, can be used to process this file. For portability, a thin wrapper may be written over parse_conf, with session oriented semantic like LoadMetadataFile(filename).

FIG. 4 shows an internal view of the DVR player 401 and DMA engine 402, and the Linux runtime 403 and other system services 404 being interfaced to both the DVR player 401 and DMA engine 402, in accordance with several embodiments of the present invention. System services 404 include graphics, file system, and timers. The DVR player 401 and DMA engine 402 are interfaced with a combination of compiled and run-time registration and callbacks. The runtime 401 and services 404 are used to link the DMA Engine 402 to the DVR player 401, and to access external content.

The DMA engine may be implemented as a portable middleware component. In other words, the DVR software comprises the majority of the runtime with DMA engine integrated with the main system software SDK. The DMA engine middleware component is integrated with the client runtime SDK and player. APIs may be used to abstract and make portable the interfaces to these subsystems: graphics plane: alpha plane to pop and teardown graphics overlay; packet callback: the callback is registered to the SDK packet processing engine so that private data packets are extracted by the player and send to DMA middleware for processing; file system: store and recall DMA graphics files; file system — content index: simple persistent flat file with catalog of all DMA related contents on DVR. Also used to track and report playback counters, history of number of graphics pop-ups, etc; VCR control events (i.e., VCR-like control events, including Play/Pause/FFWD/Rewind/Stop): DMA primary use is enabled during fast-forward. Then DMA needs to be notified when the DVR is fast-forward, and then when reversed or normal play speed. It is possible for DMA to pop graphics at normal play speed, but that is governed by product definition and it may be undesirable since it would cause the graphic to pop over a normal play speed spot.

The real-time packet callback is the primary interface for DMA engine to receive private data packets with DMA control on-the-fly. With some additional client software, it may be also possible to add a simple MPEG2 parser that can off-line scan DVR archive files to search for DMA enabled content. This information can be stored in the DMA content catalog. Then if the DMA engine is notified when a DMA content is played back, it can pre-arm the trigger and wait on fast-forward notification.

A simplified Proof of Concept (POC) system can be implemented on a Linux laptop using a run-time player such as totem, gstreamer, or mplayer. This POC system emulates the target DVR environment and allows the DMA engine to be implemented and tested independently of the DVR SDK. The POC system may use pre-loaded DMA spot files and graphics files instead of streaming contents over a network.

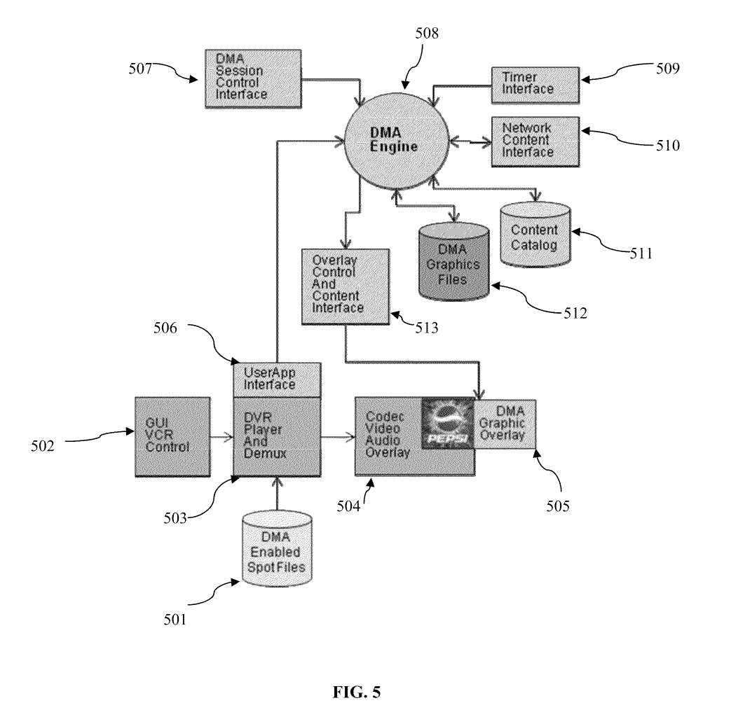

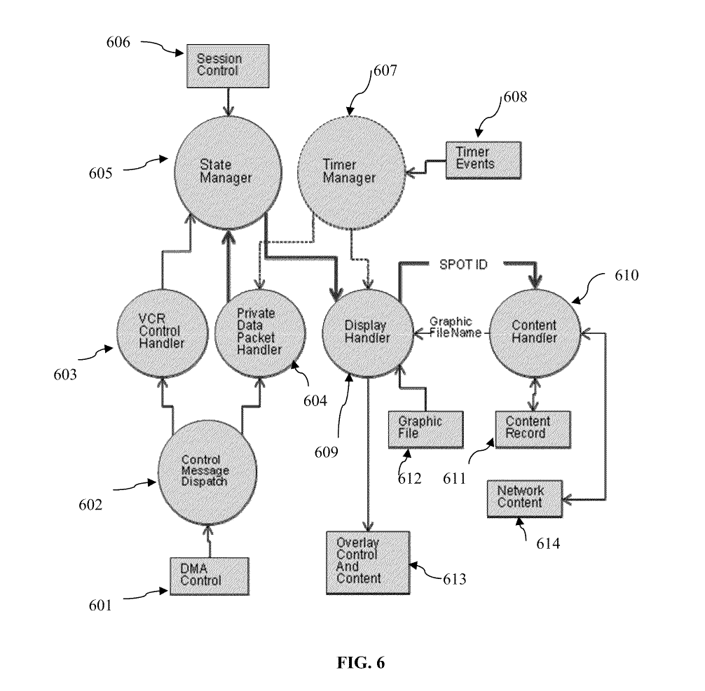

In the following tables, 3 and 4, a description of the elements from FIG. 5 and FIG. 6 is provided. Element types are one of:

TABLE 3
List of Element Types

| Element Type | General Description |
|---|---|
| Component | The element provides an essential data transformation, data buffering, or timed |
| | based process |
| Content | The element is a source or sink of video, audio or graphics. These generally have |
| | the property that they are large, may have frame and time related aspect to ‘play’ |
| | or ‘display’ |
| Database | The element is a structured collection of records that describe properties of |
| | metadata jobs or content. |
| Dataflow | The element is a message or event that flows between components. A message |
| | contains actionable control data. An event is a discrete control or time signal. |
| External | The element is external to DMA |
| Interface | The element is a source or sink of a dataflow, or timer event. A source sends |
| | output data, and a sink receives input data. |
| Metadata | The element is a collection of data that describe a content. Content attributes |
| | include control and time related fields. |

TABLE 4
Element Dictionary

| | | | | | |
|---|---|---|---|---|---|
| | Element | Element | | | |
| El. # | Name | Type | Input | Output | Functional Description |

FIG. 5

| | | | | |
|---|---|---|---|---|
| 501 | DMA Enabled | Content | | Spot File with embedded DMA triggers |
| | Spot Files | | | |
| 502 | GUI VCR | External | | Source of user interactive VCR controls. |
| | Control | | | |
| 503 | DVR Player | External | | Decodes and displays media content |
| | and Demux | | | Interactively. |
| | | | | De-multiplex DMA private data packets. |
| 504 | Codec Video, | External | | Multimedia compressed content |
| | Audio, | | | decoders, video frame buffer, audio |
| | Overlay | | | channel, graphics alpha plane |
| 505 | DMA | Content | | Alpha plane video overlay display or |
| | Graphic | | | hide single image (JPEG, PNG, etc) |
| | | | | animated image; or picture-in-picture |
| 506 | UserApp | | Private data | Adaptation interface integrated with |
| | Interface | | packets and | DVR player. Source of DMA private |
| | | | VCR control | data packets and VCR control events |
| | | | events | |
| 507 | DMA Session | Interface | Session | Source of system level process control |
| | Control | | Control | to start, stop, suspend, or resume DMA |
| | Interface | | Messages | engine. Startup includes configurable |
| | | | | session settings. |
| 508 | DMA Engine | Component | | DMA spot file and content processing |
| | | | | Decomposed in FIG. 6 |
| 509 | Timer | Interface | Timer | Source of timer events for DMA engine. |
| | Interface | | Events | |
| 510 | Network | Content | | WAN source for out-of-band content |
| | Content | | | record updates |
| | Interface | | | |
| 511 | Content | Database | | List of DMA graphics files registered in |
| | Catalog | | | the DMA Engine. Contains content records |
| | | | | referenced by Spot ID. The content record |
| | | | | includes the name of the graphic file |
| | | | | associated to the Spot ID. |
| | | | | The content catalog persists as a system |
| | | | | file. A content catalog system file can |
| | | | | be copied on and off the system. More |
| | | | | than one content catalog can be in use. |
| 512 | DMA Graphics | Content | | Single image (JPEG, PNG, etc), |
| | Files | | | animated image; or picture-in-picture |
| 513 | Overlay | Interface | | Sink for alpha plane overlay content and |
| | Control and | | | control messages. A content is a DMA |
| | Content | | | graphic file. A control is one of show, |
| | Interface | | | hide, or blend the content in the alpha |
| | (OCCI) | | | plane. |

FIG. 6

| | | | | | |
|---|---|---|---|---|---|
| 601 | DMA Control | Dataflow | | | Private data packets and VCR controls. |
| 602 | Control | Component | | | Receives DMA private data packets and |
| | Message | | | | VCR controls, and dispatches to |
| | Dispatch | | | | respective handlers |
| 603 | VCR Control | Component | GUI | | Depending on VCR control, this component |
| | Handler | | Events | | sends arm or disarm input to state manager |
| 604 | Private Data | Component | Private Data | | This component extracts SpotID from |
| | Packet | | Packets, and | | private data packet, and sends it to the |
| | Handler | | Timer Events | | state manager. |
| | | | | | It also executes timed based updates to |
| | | | | | expire a previously received Spot ID and |
| | | | | | sends the expire notification to the |
| | | | | | state manager. |
| 605 | State | Component | | | Processes arming and spot ID inputs to |
| | Manager | | | | alter the DMA engine state. If state is |
| | | | | | armed, then a spot ID input is sent to |
| | | | | | display handler. |
| 606 | Session | Dataflow | | | One of start, stop, suspend, or resume. |
| | Control | | | | Start initializes the DMA engine and |
| | | | | | readies it for normal operation. Stop |
| | | | | | halts DMA engine. Suspend and Resume |
| | | | | | cause the DMA engine to pause or return |
| | | | | | to normal operating mode. This can be |
| | | | | | in response to power managed changes at |
| | | | | | system level. |
| | | | | | Startup includes configurable session |
| | | | | | settings such as overlay Persist |
| | | | | | duration, display orientation, and alpha |
| | | | | | preferences. |
| 607 | Timer | Component | Timer | | Timed based periodic scheduling. |
| | Manager | | Event | | Notifies Packet Handler and Display |
| | | | | | Handler to execute timed based updates. |
| 608 | Timer | Dataflow | | | Rate monotonic periodic continuous signal, |
| | Events | | | | or one-time use wakeup timer that is set |
| | | | | | and counted down to expire in the future. |
| 609 | Display | Component | Spot ID, and | | Processes spot ID inputs to alter overlay. |
| | Handler | | Timer | | A Spot ID is sent to the content handler |
| | | | Events | | to look up a content record. If a valid |
| | | | | | record is located for the Spot ID, then |
| | | | | | the Graphic File name is returned. Then |
| | | | | | the graphic file is opened and written to |
| | | | | | the OCCI, along with a control output to |
| | | | | | enable the overlay. |
| | | | | | It also executes timed based updates to |
| | | | | | expire a previously displayed overlay. |
| | | | | | At a configurable overlay “Persist” delay, |
| | | | | | the overlay is automatically hidden by |
| | | | | | sending control output to OCCI. The hide |
| | | | | | may cut or fade the overlay depending on |
| | | | | | configurable session preference. |
| | | | | | A change in Spot ID causes any active |
| | | | | | overlay to be re-processed. If a new Spot |
| | | | | | ID with graphic file is located it is |
| | | | | | output to the OCCI to replace the active |
| | | | | | overlay. |
| | | | | | If the Spot ID does not have a valid |
| | | | | | graphic the active overlay is hidden. |
| 610 | Content | Component | Spot ID. | Graphic | Process the content catalog to load and |
| | Handler | | Content | File Name | save it from system file when DMA |
| | | | Catalog | | engine is started or stopped. Content |
| | | | Network | | Catalog updates insert or delete content |
| | | | Content | | records. Content updates can be in-band |
| | | | | | or out-of-band |
| 611 | Content | Content | | | A content record that is looked up using |
| | Record | | | | Spot ID to search the Content Catalog. |
| | | | | | The content record includes the name of |
| | | | | | the graphic file associated to the Spot ID. |
| 612 | Graphic File | Content | | | A graphic file associated with a Spot ID |
| | | | | | used for DMA overlay display. |
| 613 | Overlay | Dataflow | | | A content is a DMA graphic File input to |
| | Control and | | | | the OCC Interface. A control input to |
| | Content | | | | the OCC Interface is used to show, hide, |
| | (OCC) | | | | or blend the content in the alpha plane. |
| 614 | Network | Content | | WAN source | Updates to content catalog. Content can |
| | Content | | | for out-of- | be targeted by individual viewer, interest |
| | | | | band content | group, zip code, and can be altered by |
| | | | | record | viewing history. Content can be refreshed |
| | | | | updates | or repurposed independently of Spot ID by |
| | | | | | altering the graphic file associated to |
| | | | | | the Spot ID. |

The DMA engine subsystems are described in the following sections:

DMA Engine. This is the main thread of execution. This may be implemented as a separate thread or standalone process. It is driven by asynchronous events from session control, user interaction and private data packets, and timer driven from a periodic timer. The DMA engine is comprised of a state manager, timer manager, along with subsystem handlers.

Once DMA engine is started and executing, then the state manager processes inputs to arm, disarm, and display and teardown DMA graphic overlay. When DMA is armed by FFWD, and a registered Spot ID is received, then the DMA graphic file is processed and displayed. A PLAY event disarms the DMA. The timer manager inputs timer events to the packet and display handlers for timed based processing.

User Application Interface. This element is integrated with the DVR Player and provides DMA interface functions. It is adapted as needed to specific DVR players, providing the “glue” that interfaces the DMA engine with the player. The outputs of this interface include private data packets and VCR control events that are input to the DMA engine control message dispatch component.

Control Message Dispatch. This component receives DMA private data packets and VCR control events that are then dispatched to the respective handlers.

VCR Control Handler. This component translates input DVR events to arm/disarm inputs to the state manager.

Private Data Packet Handler. This component receives DMA private data packets de-multiplexed by the DVR Player from the content stream. Packets are received when a DMA enabled spot is played. The Spot ID is extracted from the packet and input to the state manager. packet handler also performs a disarming function to detect when a local content that is NOT DMA enabled is playing.

Content Handler. This component interfaces to the content catalog file that lists DMA graphics content. When a DMA control packet is called back to the DMA engine, the content handler searches content records the catalog indexing by Spot ID from the DMA control packet. If the spot ID is found and is active (not expired) in the catalog, then the spot is armed. If the spot is FFWD then DMA content is displayed, in which case Content Handler tallies the playback counter in the content record. In future extensions content handler will support off-hours content pull and usage upload to the DMA content management system server.

Display Handler. When DMA engine is armed, this component receives extracted Spot ID for overly display. The Spot ID is send to the Content Handler to look up the associated graphic file. If an associated graphic file name is returned, then the display setup opens the graphics file and sends it to the OCCI to overlay graphics over video on the system video display. A display teardown removes the graphic from the display. A display teardown will occur if a new Spot ID is received, or the display persist timer expires.

Below is a DMA engine code sample; this code sample shows how the state machine processes a VCR control message; if a metadata packet is present, then it sets up the pop-up display:

case DMA_SUBSYSTEM_EVENT:

ctx−>armed = value;
if ((PLATFORM_EVENT_FFWD == value) && (ctx−>packetID))
{

// check if a display is not already active
if (DISPLAY_STATE_IDLE == ctx−>display_state)
{

display setup(ctx−>packetID);

}

}
break;

The DMA engine may be installed by DVR manufacturer when the product is assembled, by the network operator when the DVR is first time activated for end-user, or installed as a patch downloaded from the network operator to the DVR over the network (no truck roll needed), or installed by the user.

Although specific embodiments have been illustrated and described herein for the purpose of disclosing the preferred embodiments, someone of ordinary skills in the art will easily detect alternate embodiments and/or equivalent variations, which may be capable of achieving the same results, and which may be substituted for the specific embodiments illustrated and described herein without departing from the scope of the present invention. Therefore, the scope of this application is intended to cover alternate embodiments and/or equivalent variations of the specific embodiments illustrated and/or described herein. Hence, the scope of the present invention is defined only by the accompanying claims and their equivalents.

What is claimed is:

1. A system for achieving the display of a substitute message during trick playback of a media content recorded on a digital video recorder, comprising:
means for obtaining an enhanced media content by multiplexing it with metadata triggers and embedding in said media content said substitute message, said substitute message being associated with said media content by a media content ID;
means for sending said enhanced media content to said digital video recorder; and,
means for detecting said enhanced media content and for displaying said substitute message when said media content is trick played.

2. The system of claim 1, wherein said substitute message is sent to and stored in the said digital recorder separate from said media content.

3. The system of claim 1, wherein said substitute message is updated as needed.

4. The system of claim 1, wherein said substitute message is timed when displayed.

5. The system of claim 1, wherein said means for detecting said enhanced media content and for displaying said substitute message implements isolated interfaces to DVR player.

6. The system of claim 1, wherein said means for detecting said enhanced media content and for displaying said substitute message are “armed” by the said metadata triggers.

7. A method for achieving the display of a substitute message during trick playback of a media content recorded on a digital video recorder, comprising the following steps, in any order:
obtaining an enhanced media content by multiplexing it with metadata triggers and embedding in said media content said substitute message, said substitute message being associated with said media content by a media content ID;
sending said enhanced media content to said digital video recorder; and,
installing in said digital video recorder means for detecting said enhanced media content and displaying said substitute message when said media content is trick played.

8. The method of claim 7, wherein said substitute message is sent to and stored in the said digital recorder separate from said media content.

9. The method of claim 7, wherein said substitute message is updated as needed.

10. The method of claim 7, wherein said substitute message is timed when displayed.

11. The method of claim 7, wherein said means for detecting said enhanced media content and for displaying said substitute message implements isolated interfaces to DVR player.

12. The method of claim 7, wherein said means for detecting said enhanced media content and for displaying said substitute message are “armed” by the said metadata triggers.
